(19) United States
(12) Patent Application Publication
(10) Pub. No.: US 2010/0058252 A1
(43) Pub. Date: Mar. 4, 2010

(54) GESTURE GUIDE SYSTEM AND A METHOD FOR CONTROLLING A COMPUTER SYSTEM BY A GESTURE

(75) Inventor: Chueh-Pin Ko, Taipei City (TW)

Correspondence Address: WPAT, PC;INTELLECTUAL PROPERTY ATTORNEYS, 2030 MAIN STREET, SUITE 1300, IRVINE, CA, 92614, US

(73) Assignee: Acer Incorporated, Taipei Hsien (TW)

(21) Appl. No.: 12/324,510

(22) Filed: Nov. 26, 2008

(30) Foreign Application Priority Data
Aug. 28, 2008 (TW) 097132971

(51) Int. Cl. G06F 3/033

(52) U.S. Cl. 715/863

(57) ABSTRACT

A gesture guide system and a method for controlling a computer system by a gesture are provided. The system includes a sensor element and a computer system. The method includes steps of: communicating the sensor element with the computer system; the computer system shows at least one gesture option and the corresponding function instruction; the sensor element detecting a gesture of the user; and the computer system executes the corresponding function instruction in response to the detected gesture.

### BACKGROUND OF THE INVENTION

1. Field of the Invention

The present invention is related to a gesture guide system and a method for controlling a computer system by a gesture; in particular, to a method allowing a user to control a computer system by a simple gesture through a gesture guide system.

2. Description of Related Art

Currently available touch screens and touch panels (e.g. TouchPad or TrackPad) have been widely applied in various electronic products, such as notebook computers, digital cameras, Personal Digital Assistants (PDA's) etc. The characteristic of the touch panel is in that a user may issue instructions to a computer system simply by touching the screen; for example, as a user is looking at a picture on a camera screen, the user may just use a finger to slide left on the screen to watch the next picture, while slide right on the screen to watch the previous picture, or hit the picture on the camera screen with the finger to enlarge the current picture. However, the action instructions for the touch panel usually just define a few frequently used action instructions employed by users, because most of users can only remember these frequently used action instructions in mind.

The present touch panel applications are mostly used as the pointer tool for notebook computers; that is, it uses a user's finger to move on the touch panel to replace the mouse and to control movement of cursor on the computer screen. But, in this approach of cursor selection, to issue an instruction to the system it inevitably requires to perform a long series of moving, selecting operations; for example, when printing a Word document, the user has to move the mouse cursor to the tool bar to select Printing; after pop-up of the print window, the cursor has to be moved to the print window to select Confirm, then the desired printing operation starts. However, such a method of use is essentially no different from the use of a mouse, causing limitation on the feature of two-dimensional input of the touch panel, unable to demonstrate complete exploitation on other functions to provide users with better efficacy. Therefore, no matter touch screen or touch panel, they are both restricted in terms of function due to user's operation habits.

Accordingly, how to provide an appropriate device and method to solve the aforementioned problems in prior art becomes the major objective of the present invention.

### SUMMARY OF THE INVENTION

The objective of the present invention is to provide a method for controlling a computer system by a gesture; especially, to a method allowing a user to control a computer system by a simple gesture.

The present invention provides a method for controlling a computer system by a gesture, comprising the following steps: communicating in signal a sensor element in signal with a computer system; the computer system showing at least one gesture option and the corresponding function instruction; the sensor element detects a gesture of a user; and the computer system executes the corresponding function instruction in response to the detected gesture inputted by the user.

The present invention also provides a gesture guide system, comprising: a sensor element, used to detect a gesture inputted by a user; and a computer system, communicates in signal with the sensor element to show at least one gesture option and the corresponding function instruction, and executing the corresponding function instruction in response to the detected gesture inputted by the user.

The gesture guide system and method for controlling a computer system by a gesture provided by the present invention is to notify and remind a user with a gesture guide interface based on the gesture pattern, which enables execution of the corresponding instruction and function of the gesture simply by drawing the gesture form prompted on the gesture guide interface.

In order to allow readers of the present application to further appreciate the characteristics and technical contents of the present invention, references are made to the following detailed descriptions and appended drawings in relevance with the present invention; whereas, the appended drawings are meant to be provided as references and illustrations, rather than being used to restrict the scope of the present invention.

### BRIEF DESCRIPTION OF THE DRAWINGS

FIG. 1(a) is a functional block diagram for a preferred embodiment of the gesture guide system according to the present invention.

FIG. 1(b) is a method flowchart for a preferred embodiment of the method for controlling a computer system by a gesture according to the present invention.

FIG. 2(a) is a diagram for a preferred embodiment of a static gesture according to the present invention.

FIG. 2(b) is a diagram for anther preferred embodiment of a static gesture according to the present invention.

FIG. 2(c) is a diagram for a preferred embodiment of a dynamic gesture according to the present invention.

FIG. 3(a) is a diagram for a preferred embodiment of the gesture guide interface according to the present invention as displayed on a display device.

FIG. 3(b) is a diagram for a preferred embodiment of the gesture guide interface according to the present invention.

FIG. 3(c) is a diagram for the picture rotation function in a preferred embodiment of the gesture guide interface.

FIG. 4 is a diagram for a preferred embodiment of a photo sensor used as a sensor element.

### DETAILED DESCRIPTION OF THE PREFERRED EMBODIMENTS

The present invention uses gestures to improve difficulties encountered in the conventional computer system operation workflow, which essentially employs a program, or a program built in the operation system, detecting a gesture as input, and such a system is hereunder briefly referred as a gesture guide system. This allows users to be free from repetitive actions of movement and selection by using a cursor; it only requires to use a sensor element to detect a user's gesture and generate the corresponding function instruction for controlling the computer system. Not only capable of executing programs in a computer system, such a function instruction may also be used to other devices internally connected to the computer system or peripheral devices externally connected to the computer system; e.g. projector devices, audio devices, display devices, storage devices, printer devices, network devices, facsimile devices, scanner devices, communication devices, photography devices, recorder devices, telephone devices and other computer system as well as devices consisting of wired or wireless connection, in which various functions of the above-mentioned devices can be manipulated by a gesture.

The initiation of such the gesture guide system can be categorized as manual run and autorun; it is possible for a user, or the computer system, to preset the initiation of autorun in the gesture guide system under a certain circumstance; for example, upon occurrence of an action such as placement of a compact disc into the computer, touch on the sensor element by a finger, opening a graphic or document file, then the autorun starts and a gesture guide interface is rendered to prompt at least one gesture option and the corresponding function instruction. Additionally, the user may also manually initiate the gesture guide system, or otherwise directly start the system with a prescribed gesture made in front of the sensor element.

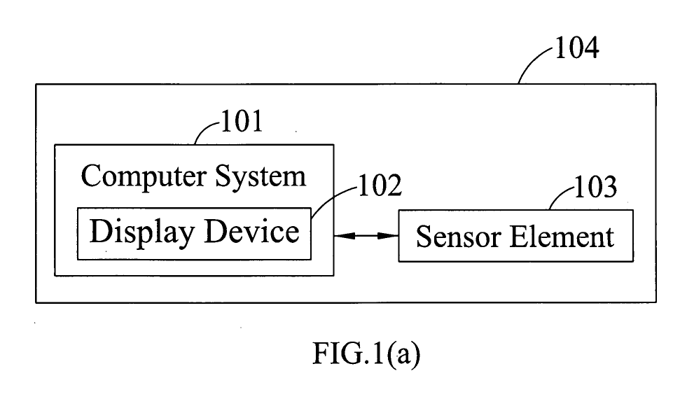

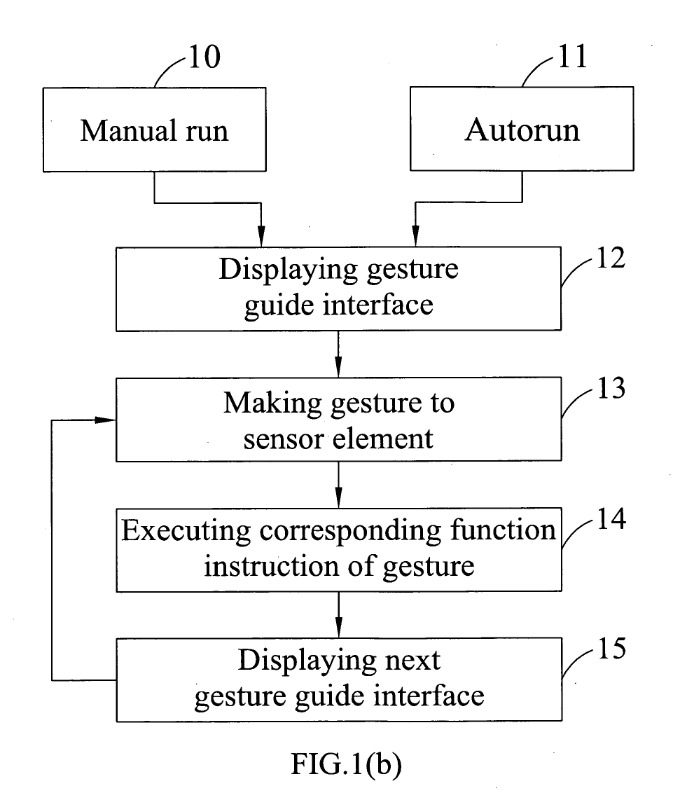

Refer now to FIGS. 1(a) and 1(b) respectively presenting a preferred embodiment of the gesture guide system and the method for controlling a computer system by a gesture. As depicted in FIG. 1(a), a functional block diagram for a preferred embodiment of the gesture guide system according to the present invention is shown. From the Figure it can be clearly seen that the gesture guide system 104 comprises a computer system 101 and a sensor element 103 communicates in signal with the computer system 101; herein the computer system 101 consists of a display device 102. The said display device 102 may be a Liquid Crystal Display (LCD), a projector, a flexible display device or an Organic Light Emitted Diode (OLED).

In order to improve the conventional drawbacks, the gesture guide system according to the present invention can implement the method flowchart for a preferred embodiment of the method to control a computer system by a gesture according to the present invention, as depicted in FIG. 1(b). After manual run (Step 10) or autorun (Step 11) of the gesture guide system, the display device 102 provides the user with a gesture guide interface (Step 12), allowing the user to select the program or the instruction based on the gesture option prompted on the display device 102 to be executed; as the user makes the gesture corresponding to the program or instruction intended to be executed over the sensor element 103 (Step 13), the computer system 101 immediately runs the function instruction corresponding to the posed gesture (Step 14). After completion of the execution, it then enters into the next gesture guide interface (Step 15), and the user may once more draw another gesture over the sensor element 103 based on the gesture option prompted on the display device 102 (Step 13) to determine the further control on the program executed in the previous step, or alternatively choose to run the next program or instruction; certainly, it is possible to draw a gesture indicating termination to end the program, too.

Since the display device 102 of the said computer system 101 can show each gesture and the corresponding function instruction to the user, such a feature allows the user to be free from memorizing each gesture definition, simply watching the displayed gesture option and drawing over the sensor element 103 the gesture corresponding to the function instruction intended to be initiated. By displaying the corresponding function instruction of each gesture on the display device 102 for the user's watching, it is possible to overcome the problem concerning incapability of remembering too many gestures in mind for users in prior art. Furthermore, the function instruction corresponding to each gesture can be defined in customization by the user, or be chosen to follow the built-in gesture settings in the computer system 101. The said sensor element 103 can be implemented by using a two-dimensional input device, such as a touch panel, a touch screen and so on, or a photo sensor.

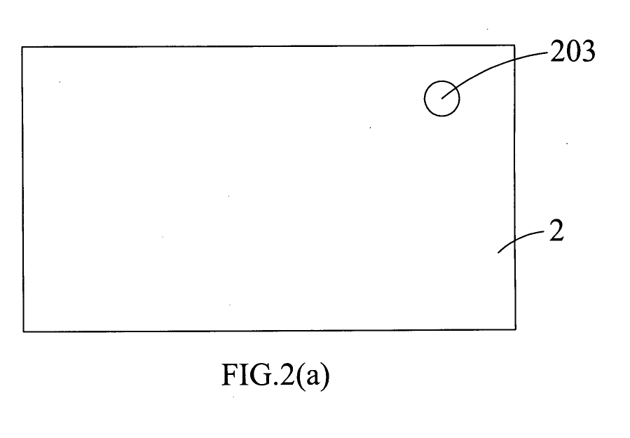

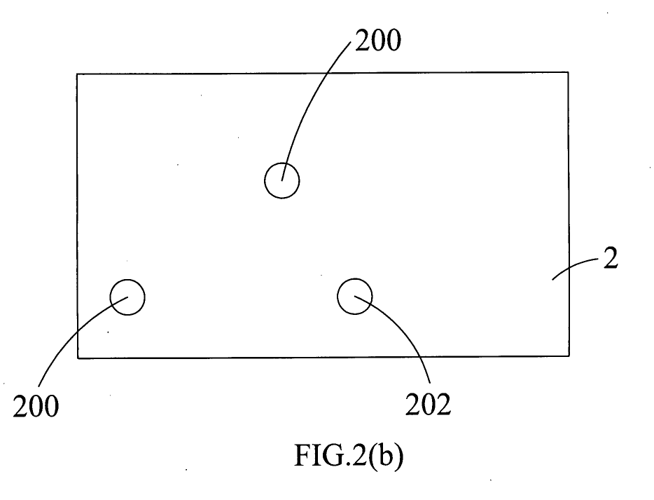

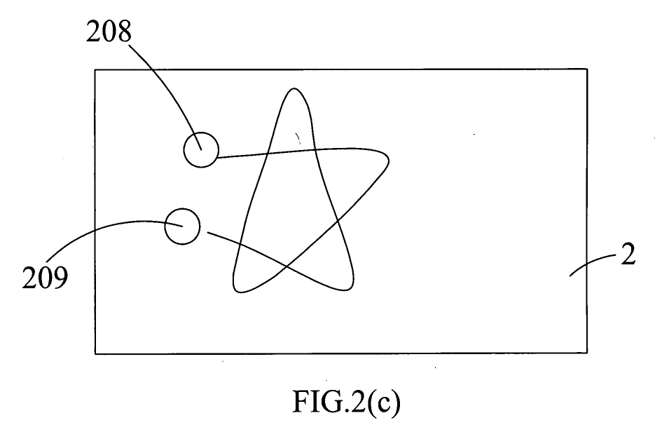

As for the definition of the gesture, it can be classified into two types: static and dynamic. The static gesture refers to simultaneous touching on the sensor element, e.g. single touch on the sensor element with one finger, or else multiple touches on the sensor element with several fingers, enabling the computer system to record through the sensor element one or more relative or absolute position of the touch done by the finger to act as the instruction. As shown in FIG. 2(a), a diagram for a preferred embodiment of a static gesture according to the present invention is illustrated. In this embodiment, assuming the sensor element is the touch panel 2 in a notebook computer, when the user intends to start the Word program, it is only required to touch the upper right corner 203 of the touch panel 2 with a finger to run the Word program. Or alternatively, as shown in FIG. 2(b), a diagram for anther preferred embodiment of a static gesture according to the present invention is depicted. To run the Word program, it is only required to simultaneously touch three points 200, 201, 202 on the touch panel 2 with fingers.

On the other hand, the dynamic gesture refers to touching on the sensor component within a duration of time, through the sensor element, it allows the computer system to record through the sensor element the movement position and movement order of the finger, and then using the movement order of the finger as the selection of forward storage or reverse storage. For example, referring to FIG. 2(c), a diagram for a preferred embodiment of a dynamic gesture according to the present invention is shown. As illustrated in the Figure, the specific gesture is about drawing a star mark within a duration of time, and in case that the user intends to set this gesture as the gesture for initiation of Word program, it is possible for the user to draw on the touch panel 2, with a finger, a star mark from the start point 208 to the end point 209 along a trace line, then select whether to be based on forward storage or reverse storage. If the user selects forward storage, then as the user intends to start the Word program later, the action of Word program initiation can be completed simply by drawing a star mark from the start point 208 to the end point 209 along a trace line with a finger. Suppose the user selects reverse storage and intends to start the Word program later, the action of Word program initiation can be similarly completed by drawing a star mark from the end point 209 to the start point 208 in a reverse order along a trace line with a finger.

Following to the descriptions set forth supra, hereunder three embodiments are provided to explain the method for controlling a computer system by a gesture according to the present invention. One preferred embodiment of the method for controlling a projector by a gesture according to the present invention is given infra.

Initially, confirm that a projector is correctly connected to a person computer or notebook computer, and such a person computer or notebook computer is installed with the sensor element. After starting the gesture guide system, it renders a gesture guide interface for the user's watching (Step 12); at this moment, the projector is still in a power-off state. Then the user can draw a first gesture to power on the projector based on the gesture option shown on the gesture guide interface (Step 13), and the computer system executes the power-on command to start the projector corresponding to the first gesture (Step 14). After starting the projector, the gesture guide system enters into next gesture guide interface (Step 15), and the user can draw a second gesture (Step 13), allowing the projector to receive signals from the personal computer or notebook computer, and projecting the picture currently shown on the computer display onto a screen (Step 14). After completion of the aforementioned actions, the gesture guide system still enters into next gesture guide interface (Step 15) to provide a gesture for relevant projector fine-tuning setting to allow the user to watch, and awaits the gesture to be made by the user; or alternatively, the user may select not to perform further fine-tunings on the projector, and make a third gesture to end the gesture guide system.

From the embodiments described heretofore, it can be seen that the gesture guide system can consistently change the gesture guide interface to allow the user to look at the gesture option and select stepwise the function to be executed, until the user decides to end the gesture guide system.

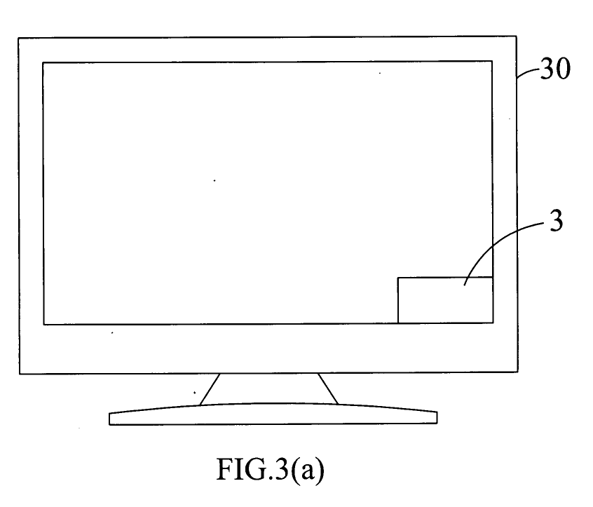

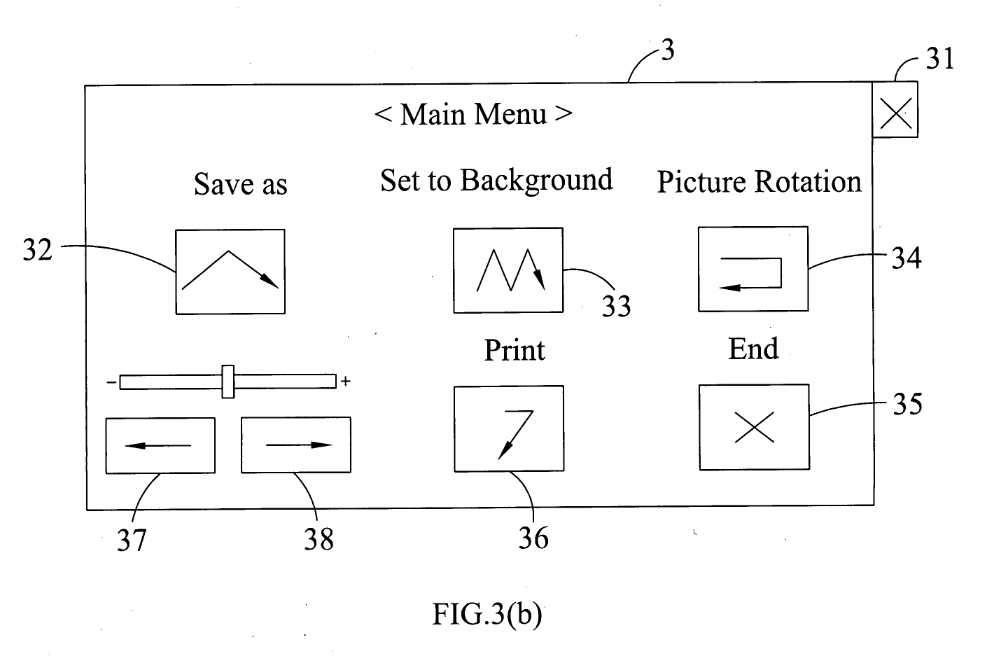

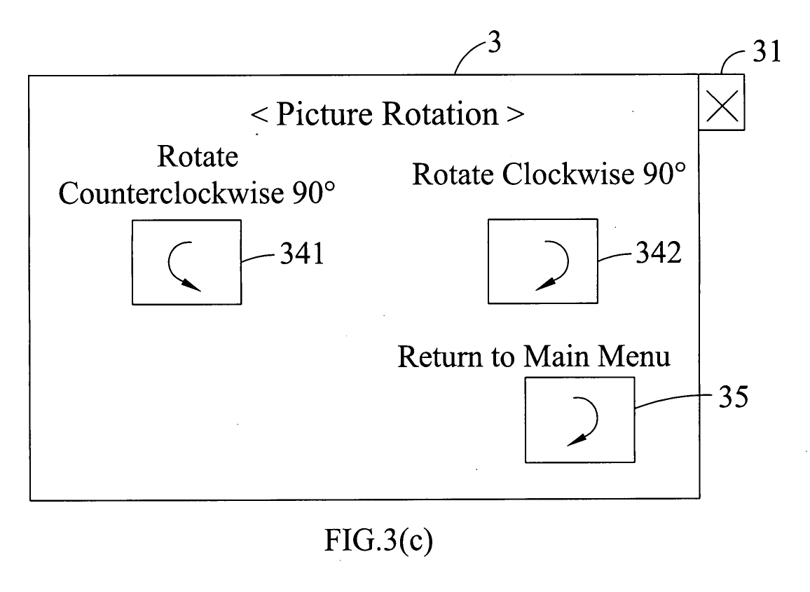

Refer now to FIGS. 3(a), 3(b) and 3(c), in which a preferred embodiment of the graphic adjustment by the gesture guide system according to the present invention is shown. As shown in FIG. 3(a), a diagram for a preferred embodiment of the gesture guide interface according to the present invention as displayed on a display device is depicted. Upon opening an picture by the user, the gesture guide system runs automatically and renders a gesture guide interface 3 on the display device 30 to allow the user to see the corresponding function instruction or program of each gesture; also, it can be clearly noted that the gesture guide interface 3 occupies simply one small portion of the display screen, so the gesture guide interface 3 does not significantly affect the display screen of user's operations during viewing or modifying the picture by the user; certainly, users may adjust the ratio and size of the gesture guide interface 3 by themselves as well.

Refer now to FIG. 3(b), wherein a diagram for a preferred embodiment of the gesture guide interface according to the present invention is shown. The gesture guide interface 3 shows the corresponding function instruction or program indicating various gestures for user's watching, such as gestures indicating functions like Save as new file 32, Setting the currently opened picture as background 33, Picture rotation 34, Print 36, Zoom in 37 and Zoom out 38. If the user temporarily does not need this gesture guide system, it is also possible to select to use the end gesture 35 to close this window, or use the mouse cursor to move to the upper right corner of the window and click on the close button 31. Suppose the user intends to use the picture rotation function by drawing a gesture 34 indicating the picture rotation function on the sensor element, then the gesture guide system automatically jumps into next gesture guide interface, allowing the user to perform further setting for the picture rotation function. As shown in FIG. 3(c), a diagram for the picture rotation function in a preferred embodiment of the gesture guide interface is depicted. In the Figure, it can be clearly seen that the gesture guide interface 3 can perform further settings about the picture rotation function according to the user selected in the previous step, in which the user may, based on the option prompted by the gesture guide interface 3, make a gesture 341 indicating 90° counterclockwise rotation or a gesture 342 indicating 90° clockwise rotation; upon completion of picture adjustment, the user may use the gesture 39 of returning to main menu to get back to the main menu.

Besides, it is mentioned heretofore that the sensor element can be implemented with a photo sensor, thus a preferred embodiment for controlling a display device by using the gesture guide system through a photo sensor is provided as below.

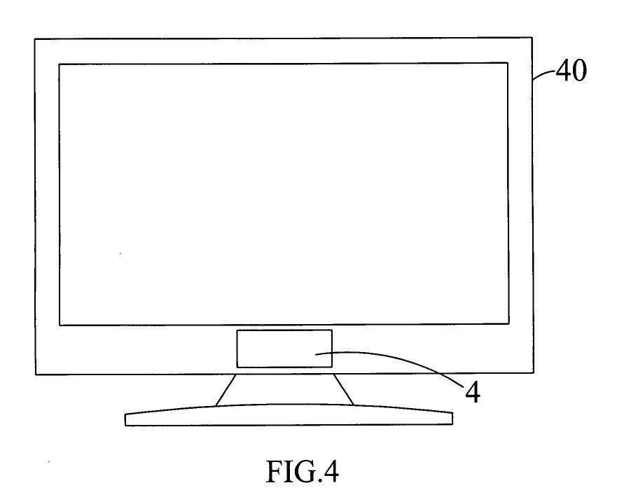

Refer now to FIG. 4, wherein a diagram for a preferred embodiment of a photo sensor used as a sensor element is shown. In the present embodiment, the photo sensor 4 is installed beneath the display device 40, and when the user intends to change the settings of the display device 40, it simply needs to turn on the on-screen display (OSD), then the computer system automatically starts the gesture guide system and renders the gesture guide interface on the screen of the display device 40. After appearance of the gesture guide interface, it is then possible to make a gesture within the sensible range of the photo sensor 4 to adjust the settings of the display device 40. For example, as the user makes a gesture of moving upper right with a hand, it enters into the context mode setting; at this moment, the gesture guide interface shows the relevant gesture option for the context mode setting, and the user may perform further setting or selection concerning the context mode based on the gesture prompted on the gesture guide interface; in case the user intends to leave this adjustment mode, the gesture guide system can be ended with a gesture indicating program termination.

In summary of the aforementioned technical descriptions, the major characteristic of the gesture guide system and method for controlling a computer system by a gesture is in that the user is informed and prompted by the gesture guide interface of a gesture pattern, and the corresponding instruction and function of the gesture can be executed simply by making the gesture figure prompted on the gesture guide interface; thus the user no longer needs to precisely move the cursor and click on a button, but can complete the operation simply by making an approximate gesture figure on the sensor element according to the displayed gesture option.

Although the present invention has been disclosed as above in accordance with the preferred embodiments thereof, it is by no means to restrict the present invention thereto. Skilled ones having common knowledge in the relevant technical fields can certainly make various alternations and modifications without departing from the spirit and scope of the present invention; therefore, the scope of the present invention to be legally protected should be delineated by the following claims. Furthermore, none of the embodiments or claims set forth in the present disclosure necessarily encompasses all objectives or advantages or features presented in the present invention. Additionally, the Abstract and Title illustrated herein are simply used to facilitate patent document searches, rather then being used to limit the scope of the present invention.

What is claimed is:

1. A method for controlling a computer system by a gesture, comprising the following steps:
a sensor element communicates in signal with a computer system;
the computer system shows at least one gesture option and the corresponding function instruction;
the sensor element detects a gesture of a user; and
the computer system executes the corresponding function instruction in response to the detected gesture inputted by the user.

2. The method for controlling a computer system by a gesture according to claim 1, wherein the computer system further comprises a display device used to display the gesture option and the corresponding function instruction.

3. The method for controlling a computer system by a gesture according to claim 2, wherein the display device can be a Liquid Crystal Display (LCD), a projector, a flexible display device or an Organic Light Emitted Diode (OLED).

4. The method for controlling a computer system by a gesture according to claim 2, wherein the corresponding function instruction of the gesture can be built in the computer system or defined by the user.

5. The method for controlling a computer system by a gesture according to claim 2, wherein the sensor element is a touch panel, a touch screen or a photo sensor.

6. A gesture guide system, comprising:
a sensor element, used to detect a gesture inputted by a user; and
a computer system, communicating in signal with the sensor element to show at least one gesture option and the corresponding function instruction, and executing the corresponding function instruction in response to the detected gesture inputted by the user.

7. The gesture guide system according to claim 6, wherein the computer system further comprises a display device used to display the gesture option and the corresponding function instruction.

8. The gesture guide system according to claim 7, wherein the display device can be a Liquid Crystal Display (LCD), a projector, a flexible display device or an Organic Light Emitted Diode (OLED).

9. The gesture guide system according to claim 7, wherein the corresponding function instruction of the gesture can be built in the computer system or defined by the user.

10. The gesture guide system according to claim 7, wherein the sensor element is a touch panel, a touch screen or a photo sensor.
